(19) United States
(12) Patent Application Publication
(10) Pub. No.: US 2005/0184426 A1
(43) Pub. Date: Aug. 25, 2005

(54) Radial contact extrusion die

(75) Inventors: Richard D. Bomba, Rochester, NY (US); John E. Benson, Webster, NY (US); Jose L. Garcia, Webster, NY (US); Thaddeus S. Gula, Rochester, NY (US)

Correspondence Address: Mark G. Bocchetti;Eastman Kodak Company, Patent Legal Staff, 343 State Street, Rochester, NY, 14650-2201, US

(73) Assignee: Eastman Kodak Company

(21) Appl. No.: 10/786,858

(22) Filed: Feb. 25, 2004

(51) Int. Cl. B29C 69/02

(52) U.S. Cl. 264/166; 425/324.1; 425/378.1

(57) ABSTRACT

An apparatus produces a patterned material which comprises an external land die (120) for extruding a material. A patterned roller (140) is in close proximity to the external land die.

### FIELD OF THE INVENTION

The present invention relates in general to apparatus for the extrusion formation of polymeric webs and in particular to an external land extrusion die, patterned roller and gimbaled mounting arrangement, that directly forms a patterned web in a manner that eliminates a free surface draw down region.

### BACKGROUND OF THE INVENTION

Literature clearly describes the extrusion of a molten material on to a moving surface. An extrusion die is typically used to create a melt curtain of desired width and thickness, which upon attachment to the roller surface, is drawn from the exit of the extrusion die.

Various means are employed to assure uniform contact of the molten material with the roller surface, such as but not limited to, a nip formed between two rollers, vacuum chambers, air knife jet, and electrostatic attraction with the intention of removing air from the interface and to create sufficient pressure to replicate the roller surface.

A die lip to roller surface gap is a consequence of all these techniques. The fluidic nature, of the molten material entering the free surface region between the die lip and the roller surface, results in a non-uniform redistribution of material. The desired thickness profile and replication of the roller surface is negatively affected by the redistribution of material which can result in thickness non-uniformities and regions of poor surface replication due to such problems as air entrainment and non-uniform contact pressure.

In conventional extrusion die to roller applications, physical constraints prevent eliminating the curtain of molten material between die lip exit and the roller surface. Mechanical requirements for extrusion die and roller construction prevent the placement of the components in a way that could eliminate a melt curtain.

A recent U.S. Patent Application Publication No. 2003/0175430 A1 (Tomaru) for a coating method and apparatus describes a concept in which a solution coating die supplies a coating solution to the interface between the exit of the coating die and the surface of a moving web. The primary intention of application is to create a uniform layer of a solution on a moving web material without intention of creating a melt extruded web with specific surface feature requirements.

An apparatus which eliminates the free surface gap between the exit of the extrusion die and the roller surface would be desirable.

### SUMMARY OF THE INVENTION

Briefly, according to one aspect of the present invention an apparatus produces a patterned material which comprises an external land die for extruding a material. A patterned roller is in close proximity to the external land die.

This apparatus eliminates the melt curtain neck-in and roller nip interface. Die lip length, converging angle, and gap between the roller surface are variables that can be optimized as a function of extrusion rate, roller surface speed, material properties, and desired final web thickness to develop a uniform pressure of sufficient level to form a continuous web with a smooth external surface on one side and replicated roller surface on the other side. This apparatus has been designed, fabricated, and tested. The die lips have extended surfaces to create a flow chamber between the die lip surface and the roller surface. Polymer is extruded into the chamber to completely fill it with resin. The roller is loaded into the die and supported by the fluid film developed within this chamber. Rotation of the patterned roller develops a shear force induced hydrodynamic pressure of sufficient level to prevent contact between the die lips and roller surface and to create a uniform, high-pressure environment to facilitate flow of the polymer into the pattern features.

The invention and its objects and advantages will become more apparent in the detailed description of the preferred embodiment presented below.

### BRIEF DESCRIPTION OF THE DRAWINGS

FIG. 1, a cross sectional isometric view representation is shown of the extended land extrusion die.

FIG. 2 shows an enlarged cross section view showing the relationship of the external land extrusion die mounted in a radial direction with respect to the patterned roller.

FIG. 3 shows a cross sectional view of an isometric representation of the radial contact extrusion die apparatus showing the external land die, patterned roller, gimbaled mounting frame, roller drive, pneumatic loading cylinders, and load indicators.

### DETAILED DESCRIPTION OF THE INVENTION

The present invention will be directed in particular to elements forming part of, or in cooperation more directly with the apparatus in accordance with the present invention. It is to be understood that elements not specifically shown or described may take various forms well known to those skilled in the art.

Referring to FIG. 1, molten material is uniformly distributed through the internal cavity 250 and the preland cavity 260 to a region constrained by the boundary surfaces of the first external die land 220, the second external die land 230 and the moving roller surface 140. The shearing action generated by the movement of the roller surface with respect to the extrusion die external lands is sufficient to create a hydrodynamic pressure force which prevents the contact of the external die lands and the roller surface. The resultant pressure on the molten material assures a highly efficient replication of the roller surface. The open end of the gap between the first external die land 220 and the patterned roller surface 140 is filled with molten material. The net flow of material across this boundary is adjusted to be zero flow. This is accomplished by balancing the flow into the boundary region from the cavity of the extrusion die with the shear induced flow caused by the movement of the roller surface. The molten material exits the open gap between the second external die land 230 and the patterned roller surface 140. A smooth surface is imparted on the surface of the web as it exits the pressurized region. The temperature and surface finish of the second external die land 230 can be varied to modify surface properties of the web material. The local metal temperature of the die can be measured with the temperature sensor 280. This sensor can be used to control the output to heater 270. Edge adjustment seals 240 are used to create a closed three dimension pressurized region that prevents the flow in a direction parallel to the axis of rotation. The edge adjustment seals 240 are contoured to the patterned roller surface and are axially adjustable to vary the extrusion die slot.

A uniform gap is maintained between the rotating patterned roller surface and the edge of the first external land and the second external land. This is accomplished under dynamic conditions through the unique gimbaled mounting of the driven patterned roller 140 to the external land extrusion die 120. Typically, the extrusion die is held rigidly with respect to the roller surface. The geometric tolerances and thermal deformation of components result in a non-uniform gap. This apparatus utilizes a two axis gimbaled mounting arrangement 100, 105, 130 that enables the driven roller to seek a uniform alignment with respect to the fixed extrusion die. The patterned roller is mounted in bearing housings that have features to provide a skewing adjustment of the roller with respect to the gimbaled frame.

The external land die 120 is fixed to the machine frame and the patterned roller 140 is mounted in a gimbaled fixture attached to the die. This arrangement allows the roller surface to align with the die surface based on the pressure developed within the flow chamber. This design compensates for mechanical tolerances to maintain adequate alignment between the roller cylindrical surface and the die lip surfaces. This concept is not limited to cast web formation but could also be applied to extrusion coating of substrates. The apparatus provides a means of extrusion coating polymeric materials that have very low melt strength. Typically low melt strength polymers are prohibited from use in an extrusion process because of melt curtain instabilities. A single stream of molten polymer has been described to this point but co-extruded, (multiple layer), molten polymer flows can be processed with this apparatus.

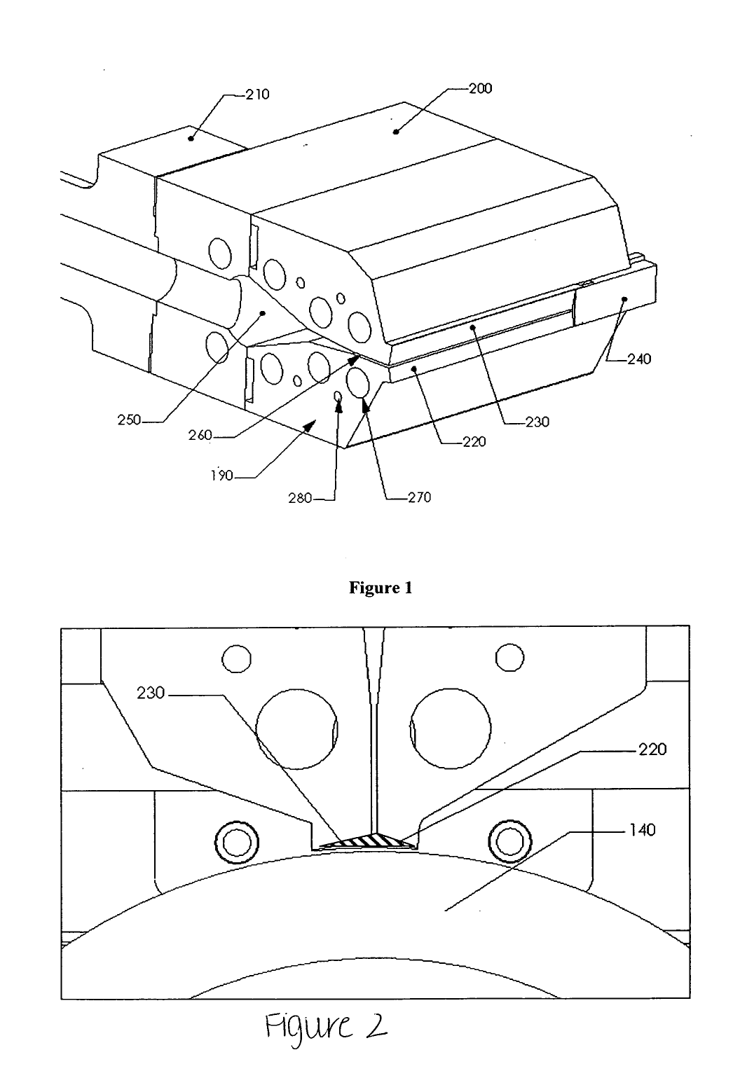

Referring to FIG. 2, the first external die land 220, second external die land 230 and the edge adjustment seal 240 in combination with the patterned roller surface 140 create a three dimensional region filled with molten material in which the web formation process occurs.

The interface region, shown shaded, represents the molten material delivered through the extrusion die into a trapezoidal region created by the first external land die land 220, the second external land die land 230, and the patterned roller surface 140. The patterned roller rotates about its primary axis of symmetry. This motion is with respect to the fixed extrusion die.

Delay in contact results in cooling of the molten material on the patterned roller before sufficient pressure is created to effectively replicate the surface. As the molten material cools the pressure required for efficient replication increases at a very high rate. Conventional approaches are to create a higher nip force to improve replication of the patterned roller surface. Higher nip loading requires a patterned roller design of high structural stiffness and strength to apply the load. The combination of higher nip loads and larger patterned roller diameter further increase the distance from extrusion die lip to the nip point. Therefore, increased neck-in of the molten material occurs along with further cooling which results in a non-uniform layer of molten material at the nip point. Even if the geometry of the nip interface is as desired, the non-uniform distribution of molten material will result in non-uniform contact pressure.

A significant feature of this apparatus is to provide a uniformly distributed molten material that is subject to a rapid pressure rise within a short dwell time to enable the molten material to fully replicate the patterned roller surface before excessive cooling of the molten material occurs thereby completing the replication process at a much lower overall nip load. The high pressure is applied over a small-localized area and at a point in which the temperature of the molten material is ideal for replication of the patterned surface. The mechanical requirements of the components are much less demanding. Therefore, a small roller can be used for an equivalent patterning process. This concept extends the range of width capability because roller deformation is proportional to the third power of roller face width. Typical wide extrusion lines, greater than 1 meter, will require larger diameter rollers. This apparatus allows more flexibility in choice of roller construction, for example roller diameter can be increased to allow increased cooling dwell time but without affecting the extrusion die to roller surface interface. Vacuum and electrostatic methods are limited to the maximum pressure that can be developed at the interface between the molten material and the patterned roller surface.

In one experiment, a polymeric material with a zero shear viscosity of 880 poise at 300° C. has been directly extruded to form a patterned web of approximately 0.150 m width by 2.5×10⁻⁴ m thick at a line speed of 0.05 m/s. The patterned surface roughness was approximately 6 micron Ra (6.0×10⁻⁶ m Ra). It is estimated that the localized pressure on the molten material was increased by a factor of thirty for a very short time. This resulted in a rapid pressure change on the order of 1.5×10⁷ Pa/s.

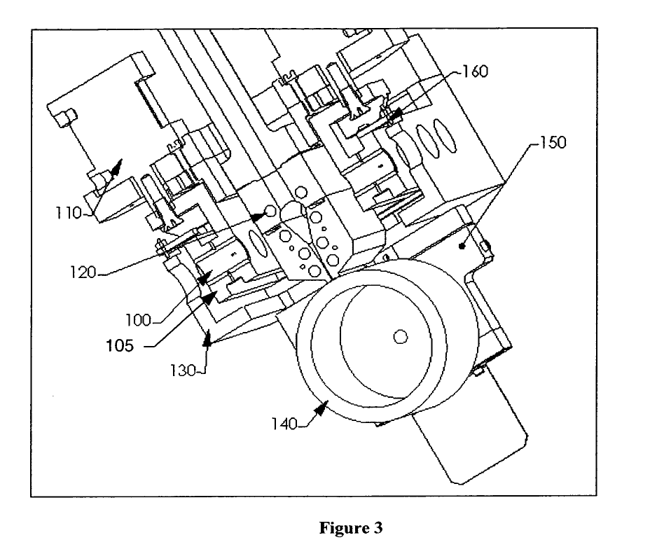

Referring to FIG. 3, the external land extrusion die 120 is supported on the inlet melt pipe 210 and both are rigidly mounted. The Y-direction gimbaled frame 105 and Z-direction gimbaled frame 130 are mounted to the external land extrusion die 120. The combination of these frames create a mounting system for the patterned roller 140 that allows the roller to reach an equilibrium position with respect to the external land regions of the die. The roller can be retracted from this position by the action of pneumatic loading cylinders 110. Air pressure acting in the cylinders establishes a reaction force to balance the hydrodynamic pressure force created at the die to roller interface. The patterned roller 140 is supported in high precision bearing mounts 150 which are attached to the Z-direction gimbaled frame 130. A fixed stop to prevent roller to die contact without molten material flow is incorporated into the support structure. A tapered wedge arrangement provides for very precise adjustment of the roller with respect to the gimbaled frame to accommodate small misalignment of the roller to die. A force measurement device is incorporated within the mounting arrangement to provide a direct indication of resultant force on the roller surface. Components have been mounted in a symmetric fashion to minimize imbalance of the gimbaled frames. Counterweights have been provided as necessary to balance the patterned roller drive. Adjustments have also been incorporated to provide an external adjustment of the roller axis with respect to the die for both the Z-direction and the Y-direction through the Z-direction gimbal angle adjustment 160 and with a similar feature the Y-direction gimbal angle adjustment.

The external land extrusion die 120 features a unique two-piece construction consisting of the rear die body 200 and the lower die body 190. Typically in practice an extrusion die is split on a plane bisecting the die slot and parallel to the width direction. A bolted joint is created along this interface to seal both halves together. This design is subject to leaks at the interface point near the exit extrusion slot which causes poor edge formation on the extruded web. This external land extrusion die 120 is cut with a plane that is parallel to the back surface of the die and which does not cut through the die slot, resulting in a homogeneous lower die body free from potential leakage points near the web formation region.

The invention has been described in detail with particular reference to certain preferred embodiments thereof, but it will be understood that variations and modifications can be effected within the scope of the invention.

### Parts List

100 Y-direction gimbal
105 Y-direction gimbaled
110 loading cylinder
120 external land extrusion die
130 Z-direction gimbaled frame
140 patterned roller
150 bearing mount
160 Z-direction gimbal angle adjustment
190 lower die body
200 rear die body
210 inlet melt pipe
220 first external die land
230 second external die land
240 edge adjustment seal
250 internal cavity
260 preland cavity
270 heater
280 temperature sensor

1. An apparatus for producing a patterned material comprising:
an external land die for extruding a material;
a patterned roller in close proximity to said external land die.

2. An apparatus as in claim 1 wherein said patterned roller is mounted on the gimbals.

3. An apparatus as in claim 2 wherein said patterned roller is constrained to allow rotation on two axes with respect to said external land die.

4. An apparatus as in claim 1 wherein said patterned roller is mounted for rotation.

5. An apparatus as in claim 1 wherein a distance between said external land die and said patterned roller is adjustable.

6. An apparatus as in claim 1 wherein said patterned roller is heated.

7. An apparatus as in claim 1 wherein said external land die comprises:
a first external land surface; and
a second external land surface.

8. An apparatus as in claim 7 wherein said first external land surface and said second external land surface form a trapezoid with respect to a surface of said patterned roller.

9. An apparatus as in claim 7 wherein:
said first external land surface creates a diverging region with respect to a direction of rotation of said patterned roller; and
said second external land surface creates a converging region with respect to said direction of rotation of said patterned roller.

10. An apparatus as in claim 9 wherein a first hydrodynamic pressure created in said diverging region is less than a second hydrodynamic pressure created in said converging region.

11. An apparatus as in claim 10 wherein said second hydrodynamic pressure is in excess of 1.0×10⁶ Pa to compress entrapped air in said material.

12. An apparatus as in claim 9 wherein the rate of pressure change in the converging region is at least 1.5×10⁷ Pa/s.

13. An apparatus as in claim 7 wherein:
a first heater heats said first external land surface; and
a second heater heats said second external land surface.

14. An apparatus as in claim 13 wherein said first heater operates at a different temperature then said second heater.

15. An apparatus as in claim 1 comprising:
a first end seal at a first end of said external land die;
a second end seal at a second end of said external land die; and
wherein said first end seal and said second end seal prevent said material from leaking past said first and second end of said external land die.

16. An apparatus as in claim 1 wherein said patterned roller is vented.

17. An apparatus as in claim 1 wherein said extruded material is molten.

18. An apparatus as in claim 1 wherein said material is comprised of at least two separate materials for coextruding at least two separate layers.

19. An apparatus as in claim 1 wherein said material is a polymer.

20. An apparatus as in claim 1 wherein said material is a low curtain strength material.

21. An apparatus for producing a patterned material comprising:
an external land die for extruding a material;
a patterned roller in close proximity to said external land die;
wherein said patterned roller is mounted on gimbals;
wherein said patterned roller is mounted for rotation; and
wherein a distance between said external land die and said patterned roller is adjustable.

22. An apparatus as in claim 21 wherein said patterned roller is heated.

23. An apparatus as in claim 21 wherein said external land die comprises:
a first external land surface; and
a second external land surface.

24. An apparatus as in claim 23 wherein said first external land surface and said second external land surface form a trapezoid with respect to a surface of said patterned roller.

25. An apparatus as in claim 23 wherein:
said first external land surface creates a diverging region with respect to a direction of rotation of said patterned roller; and
said second external land surface creates a converging region with respect to said direction of rotation of said patterned roller.

26. An apparatus as in claim 25 wherein a first hydrodynamic pressure created in said diverging region is less than a second hydrodynamic pressure created in said converging region.

27. An apparatus as in claim 26 wherein said second hydrodynamic pressure is in excess of 1.01×10⁶ Pa to compress entrapped air in said material.

28. An apparatus as in claim 23 wherein:
a first heater heats said first external land surface; and
a second heater heats said second external land surface.

29. An apparatus as in claim 21 wherein said pattern roller has a depth of at least 6 microns.

30. An apparatus as in claim 28 wherein said first heater operates at a different temperature then said second heater.

31. An apparatus as in claim 21 comprising:
a first end seal at a first end of said external land die;
a second end seal at a second end of said external land die; and
wherein said first end seal and said second end seal prevent said material from leaking past said first and second end of said external land die.

32. An external land die for extruding a material comprising:
a first external land surface;
a second external land surface; and
wherein said first external land surface and said second external land surface form a trapezoid with respect to a surface of a patterned roller.

33. An apparatus as in claim 32 wherein:
said first external land surface creates a diverging region with respect to a direction of rotation of said patterned roller; and
said second external land surface creates a converging region with respect to said direction of rotation of said patterned roller.

34. An apparatus as in claim 33 wherein a first hydrodynamic pressure created in said diverging region is less than a second hydrodynamic pressure created in said converging region.

35. An apparatus as in claim 34 wherein said second hydrodynamic pressure is in excess of 10 atmospheres to compress entrapped air in said material.

36. An apparatus as in claim 33 wherein:
a first heater heats said first external land surface; and
a second heater heats said second external land surface.

37. An apparatus as in claim 36 wherein said first heater operates at a different temperature then said second heater.

38. A method for producing a patterned web comprising the steps of:
heating a material which comprises said web;
pumping said material into a cavity at a controlled rate;
distributing said material over a length of a slot;
forcing said material into a cavity formed by a first external land surface, a second external land surface and a surface of a patterned roller; and
partially solidifying said material under high-pressure.

39. A method as in claim 38 further comprising:
continuing solidification of said material on said patterned roller after it exits said cavity.

40. A method as in claim 38 wherein said web is stripped from said patterned roller.

41. An apparatus for producing an extruded material comprising:
an external land die for extruding said material;
a roller in close proximity to said external land die;
wherein said roller is mounted on gimbals;
wherein said roller is mounted for rotation; and
wherein a distance between said external land die and said roller is adjustable.
